(19) United States
(12) Patent Application Publication
(10) Pub. No.: US 2003/0142435 A1
(43) Pub. Date: Jul. 31, 2003

(54) Magnetic disk apparatus, magnetic recording medium and method of servo waiting

(76) Inventors: Futoshi Tomiyama, Hachioji (JP); Takehiko Hamaguchi, Fuchu (JP); Atsushi Kikugawa, Higashimurayama (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/237,675

(22) Filed: Sep. 10, 2002

(30) Foreign Application Priority Data
Jan. 31, 2002 (JP) 2002-022679

(51) Int. Cl. G11B 21/02; G11B 5/09

(52) U.S. Cl. 360/75; 360/48

(57) ABSTRACT

There is provided a magnetic disk apparatus incorporating a perpendicular recording medium that employs a servo information writing method which is less likely to cause servo errors. A magnetic disk apparatus incorporates a recording medium whose servo areas are so designed that there is at least one point having no servo sector, on the line connecting the recording medium pivot and an arbitrary point on the outermost track of the medium, in a system which satisfies the relation of B×N>2π where B represents the angle of the area (sector) occupied by the locus of a servo pattern with respect to the recording medium pivot and N represents the number of servo samples.

### FIELD OF THE INVENTION

The present invention relates to a servo writing method for recording a servo pattern on a magnetic disk that minimizes noise, caused by instability in the magnetic domain structure of a soft magnetic underlayer (hereinafter referred to as “spike noises”), in a magnetic disk apparatus which uses a perpendicular recording medium having a soft magnetic underlayer and has a rotary actuator as a head positioning mechanism.

### BACKGROUND OF THE INVENTION

For higher density magnetic recording, research has been conducted on perpendicular recording that uses a double-layer perpendicular recording medium having a soft magnetic underlayer. FIG. 1 is a schematic diagram showing a double-layer perpendicular recording medium. A soft magnetic underlayer 2 is formed on a magnetic disk substrate 3 which functions as a return path for the recording magnetic field from the recording head during recording, and a magnetically recording layer perpendicular to the plane 1 is laid over the underlayer 2.

For commercial use of a double-layer perpendicular recording medium, there is a problem regarding spike noises attributable to a magnetic wall generated in the soft magnetic underlayer 2. Due to the presence of spike noise, the recorded information to be read is modulated, which leads to an increase in errors. Although studies have been made about various methods for preventing spike noise, there is still no method which completely eliminates spike noise.

One approach to decreasing the incidence of spike noise is to provide the soft magnetic underlayer 2 with a single magnetic domain. According to this approach, a magnetic anisotropy in the radial or circumferential direction of the recording medium is provided to the soft magnetic underlayer in the medium manufacturing process. If a radial anisotropy, spike noises with linear shapes tend to be distributed in the radial direction continuously. On the other hand, if a circumferential anisotropy is provided, spike noises with linear shapes tend to be distributed in the circumferential direction continuously. Therefore, when a circumferential anisotropy is provided, there will be more data recorded in the area where spike noises are distributed. In signal processing, fewer error bytes per interleave is preferable for data correction. For this reason, a radial anisotropy is more likely to be provided.

FIG. 10 and FIG. 11 show an example of servo writing to a magnetic recording medium with an anisotropic easy axis in the radial direction in the soft magnetic underlayer according to the prior art. Dotted line 25 in FIG. 10 and bold line 25 in FIG. 11 indicate spike noises. In FIG. 10, B indicates the angle of a sector where the locus of a servo pattern spreads. In the case illustrated in FIG. 10, the number of servo samples is as small as 8, so servo writing is performed without causing any of these servo pattern loci to cross a line of spike noises. However, if the number of servo samples is increased as illustrated in FIG. 11 (the number of servo samples is 32 in the case illustrated in FIG. 11), there will be a locus of a servo pattern that inevitably crosses a line of spike noises. The servo area, which is involved in magnetic head position control, is more affected by the spike noises than the user data area. For this reason, it is desirable to minimize the possibility that lines of spike noises cross servo pattern loci.

However, with the growing trend toward higher track densities in magnetic disk apparatuses, there is a tendency for the number of servo samples to increase. Even though angle B of the servo pattern sector with respect to the center of the recording medium changes depending on the magnetic disk apparatus structure, generally speaking, if the number of servo samples exceeds 100 or more, then the value of N×B is supposed to exceed 2π. In other words, the sector occupied by the locus of a servo pattern extends into an adjacent sector. For example, in a magnetic disk apparatus whose surface recording density is not less than 30 gigabits per square inch, the number of servo pattern sectors is usually over 100.

Accordingly, if spike noises are generated in a system that satisfies the relation of N×B≧2π (B and N represent an angle and the number of servo samples respectively), spike noises will inevitably cross a plurality of servo pattern loci. A plurality of servo areas are formed on the locus of the servo pattern. Since it is almost impossible to reproduce a servo signal from a servo area that is formed at the point of intersection with a line of spike noises, it is impossible to position the head to a data area adjacent to the servo area. Therefore, the recording capacity of the disk apparatus is reduced. As the number of servo samples increases, more servo areas cross lines of spike noises, so the problem caused by spike noise becomes more serious.

### SUMMARY OF THE INVENTION

In the prior art, for a system where a servo pattern is formed with high density as illustrated in FIG. 11, it was impossible to write the servo pattern avoiding crossing long, straight lines of spike noises.

Therefore, the primary object of the present invention is to provide a magnetic disk apparatus having a servo area that is less likely to cause servo errors due to noises attributable to an instability in the magnetic domain structure of the soft magnetic underlayer, and also to provide a servo writing method for the servo area in a magnetic disk apparatus using a double-layer perpendicular recording medium.

In order to achieve the above objects, according to one aspect of present invention, a servo area is divided in the radial direction of the recording medium such that the above-mentioned angle B is not more than 2π/N with respect to the number of servo samples N.

According to another aspect of the invention, assuming that the data recording range in the radial direction of the recording medium is defined by Rin and Rout (Rin represents the innermost side of the recording medium and Rout the outermost side), a magnetic disk apparatus incorporates a recording medium whose servo area is designed such that there exists at least one point on Rout (or the nearest track to the Rout) at which no servo sector is formed on a straight line connecting the point on the Rout and the center of the recording medium.

### BRIEF DESCRIPTION OF THE DRAWINGS

FIG. 1 shows the layer structure of a perpendicular recording medium having a soft magnetic underlayer;

FIG. 2 shows a spike noise distribution in a perpendicular recording medium having a soft magnetic underlayer that has an anisotropic easy axis in the radial direction;

FIG. 3 shows a plan view of a magnetic disk apparatus;

FIG. 4 shows a cross sectional view of a magnetic disk apparatus;

FIG. 5 shows a configuration of a servo area and a data area in a track;

FIG. 6A shows an enlarged diagram used for explaining a servo area;

FIG. 6B shows a reproduced servo burst signal in the servo area of FIG. 6A;

FIG. 7 is a plan view of a servo track writer;

FIG. 8 shows an arrangement of a magnetic recording medium and a rotary actuator in a magnetic disk apparatus;

FIG. 9 shows a path of a rotary actuator in a magnetic disk apparatus;

FIG. 10 shows a path of the servo pattern as a result of servo writing using a prior art, under a circumstance that the number of servo sectors is as small as 8;

FIG. 11 shows a path of the servo pattern as a result of servo writing using a prior art, under a circumstance that the number of servo sectors is increased to 32;

FIG. 12 shows a path of the servo pattern as a result of servo writing according to the present invention under a circumstance that the number of servo sectors is increased to 32;

FIG. 13 shows a path of the servo pattern as a result of servo writing according to the present invention under a circumstance that the number of servo sectors is increased to 32;

FIG. 14 shows the general structure of the servo track writer used in the first, second and third embodiments of the invention;

FIG. 15 is a flowchart showing the servo track writing sequence based on the prior art;

FIG. 16 is a flowchart showing the servo track writing sequence according to the first embodiment of the invention; and

FIG. 17 is a flowchart showing the servo track writing sequence according to the third embodiment of the invention.

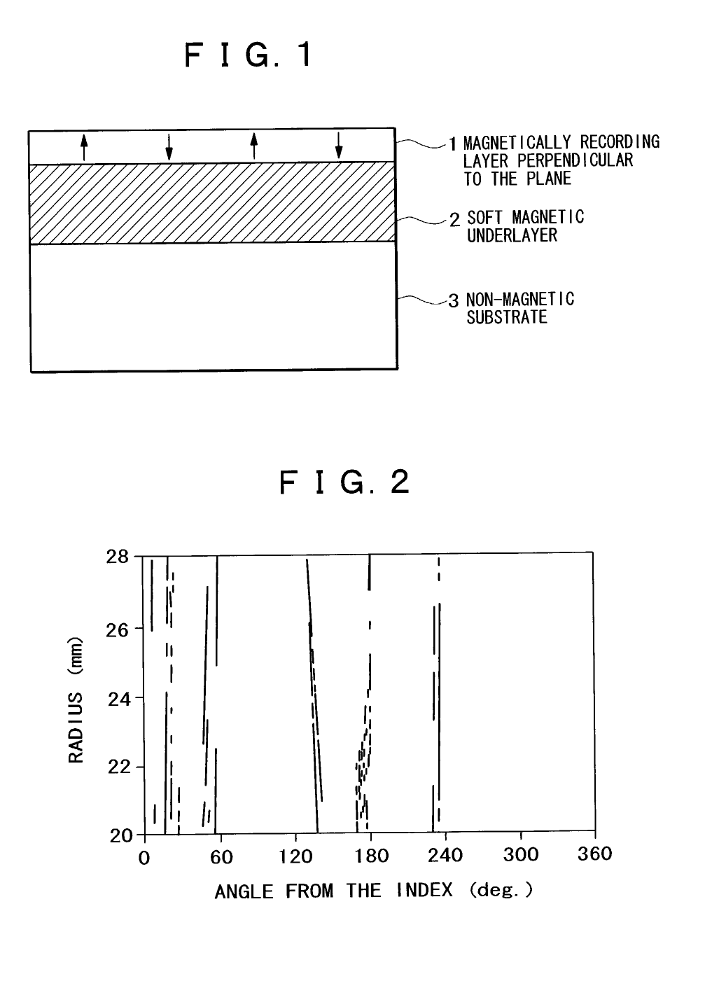

### DETAILED DESCRIPTION OF THE PREFERRED EMBODIMENTS

Embodiment 1

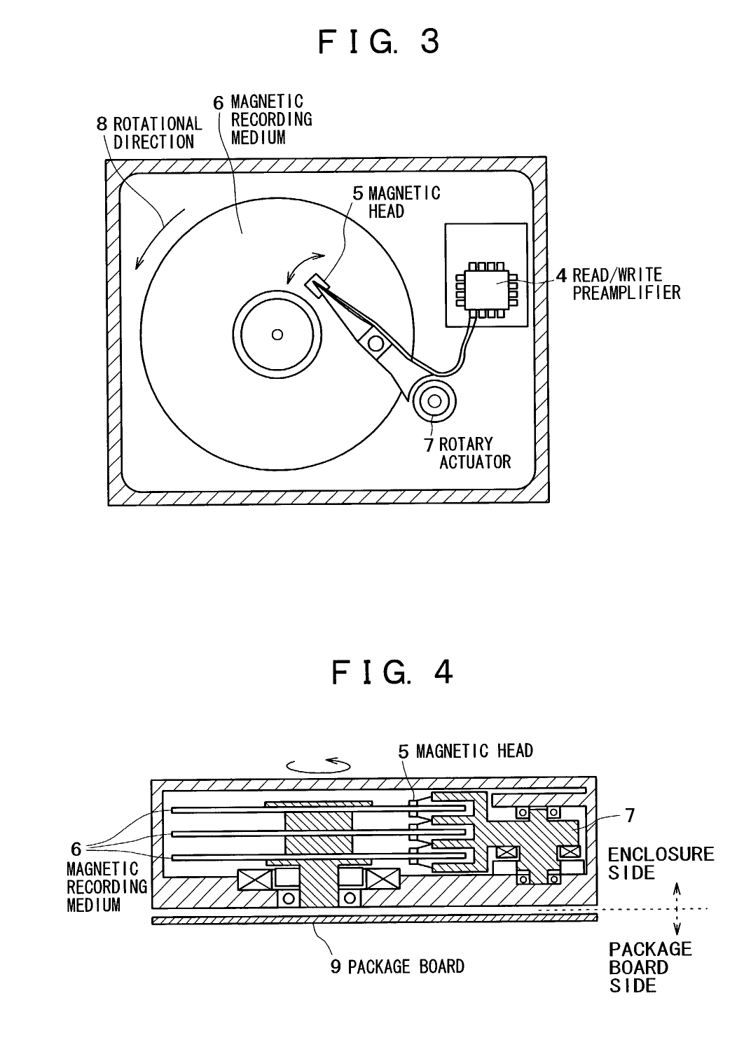

FIG. 3 is a plan view of a magnetic disk apparatus according to the first embodiment of the present invention and FIG. 4 is a cross-sectional view thereof. In the FIGS. 3 and 4, numeral 4 is a signal processor for processing information forwarded to or collected from the magnetic head, numeral 5 is a magnetic head slider onto which the magnetic head is mounted, 6 is a magnetic disk medium, 7 is rotary actuator, 8 indicates a direction of rotating the magnetic disk medium, and 9 is a package board on which a processor or memory is mounted.

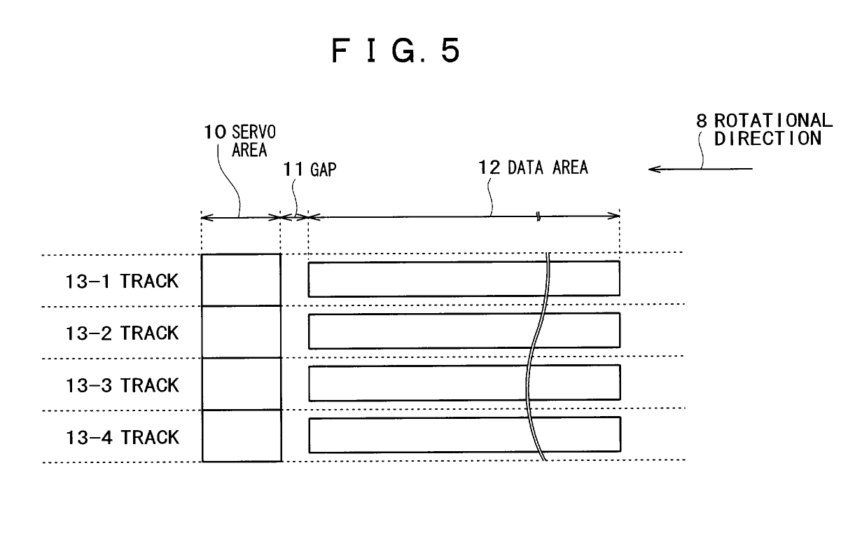

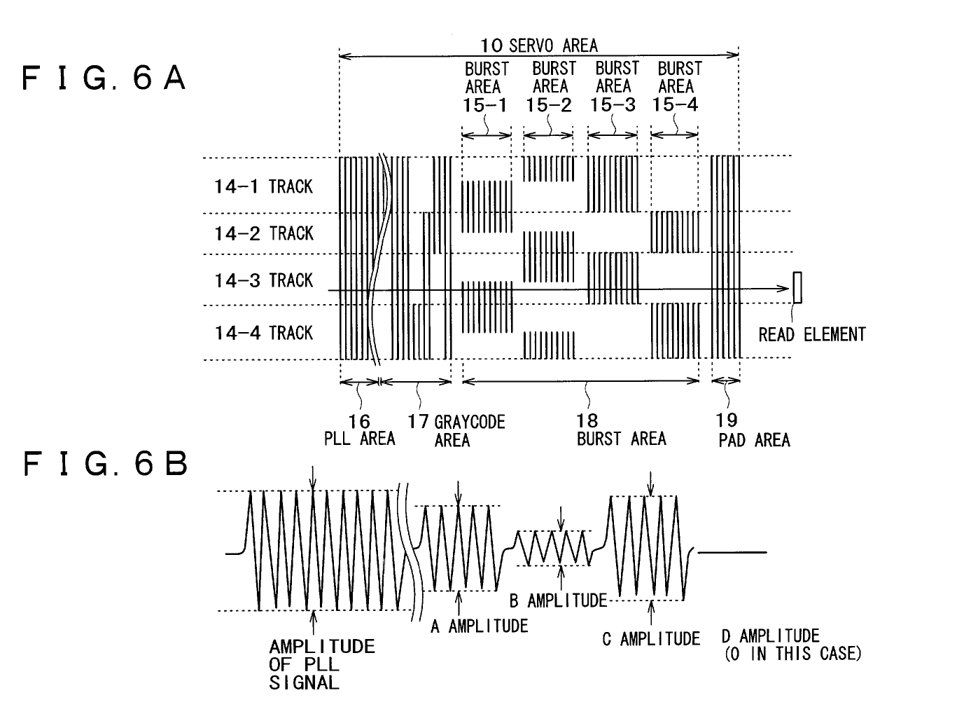

For the sake of compactness, conventional magnetic disk apparatus usually uses a rotary actuator 7 as a head positioning mechanism. FIG. 5 shows a configuration of a servo area and a data area that constitute a track. Referring to FIG. 5, each of tracks 13-1 to 13-4 is usually composed of a servo area 10 and a data area 12. To secure a margin for buffering a fluctuation attributable to rotational jitter or the like, a gap 11 is usually formed between the servo area 10 and the data area 12. In order to explain the details of the servo area, an enlarged servo area 10 of FIG. 5 is shown in FIG. 6A. FIG. 6B shows reproduced servo burst signals A, B, C, D corresponding to the numeral 15-1 through 15-4 of FIG. 6A, respectively. To access any of tracks 14-1 through 14-4, gray code 17 is read to identify the track number and the target track is roughly accessed, then burst signals, for example, numerals 15-1 through 15-4 are reproduced, and an accurate tracking (track following) to the target track proceeds based on an intensity of the reproduced servo burst signals A, B, C and D.

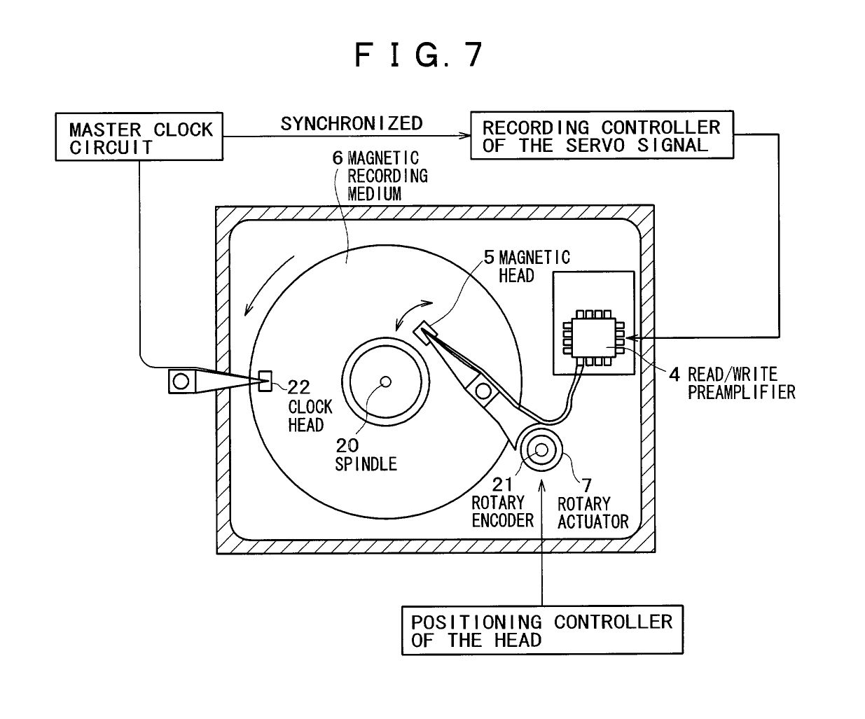

In this embodiment, a servo pattern is formed with a servo track writer. FIG. 7 is a schematic diagram showing the servo track writer. Since a magnetic disk apparatus is not equipped with any means for detecting a head position before a servo signal is recorded, a rotary encoder 21 is attached to the rotary actuator 7 in order to get the information on the head position with respect to the radial direction of the disk as an angle of rotation. The magnetic recording medium 6 is rotated by spindle 20. The positioning controller of the head controls an operation of the rotary actuator to move the magnetic head 5 gradually and record the servo signal. In recording of the servo signal, the procedure is carried out by the magnetic head 5 on a magnetic recording medium 6, while always counting the timing of recording to a rotational synchronized pulse, which is obtained from a periodic signal reproduced by a clock head 22. Because the same rotational synchronized pulse reproduced by the clock head 22 is used to record the servo signal, a shape of the recorded servo signal becomes an arc along a path of the magnetic head moved by the rotary actuator as shown in FIG. 9.

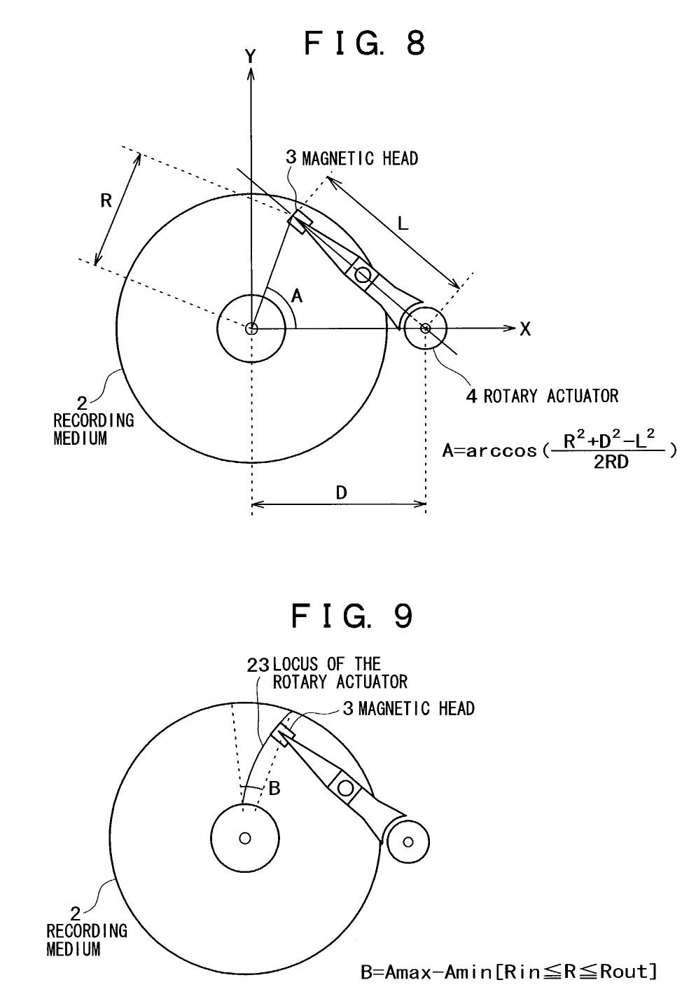

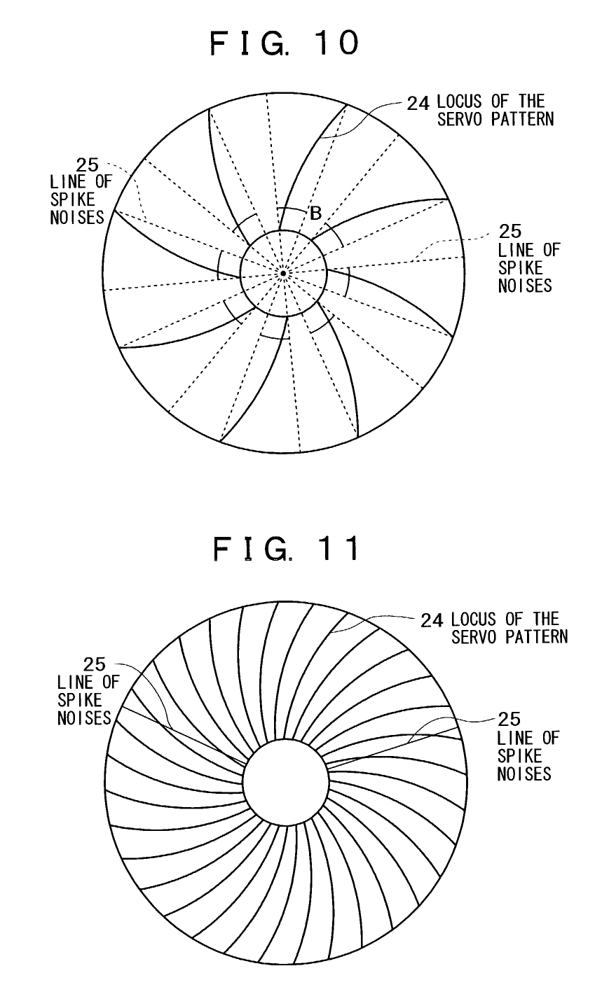

Assuming that a radius of the area that information is recorded on the magnetic recording medium is within Rin to Rout, the angle B (an angle traversed by a servo pattern) determined by the path of a movement of the magnetic head (due to the movement of the rotary actuator) within Rin and Rout can be defined using the angle A shown in FIG. 8.

Angle A is an angle determined by the position of the magnetic head on the medium, the center of the recording medium and the position of the center of the rotary actuator, and defined by the following formula:

A=arccos [(R²+D²-L²) (2RD)],

where

R=Head element position radius [Rin≦R≦Rout];

D=Distance between the disk pivot and rotary actuator pivot; and

L=Distance between the rotary actuator pivot and read/write head element position.

On the other hand, B is defined by the following formula:

B=Amax−Amin,

where

Amax=maximum value of A within the range of Rin≦R≦Rout; and

Amin=minimum value of A within the range of Rin≦R≦Rout.

In this embodiment, the product of N and B is greater than 2π, namely N*(Amax−Amin)>2π.

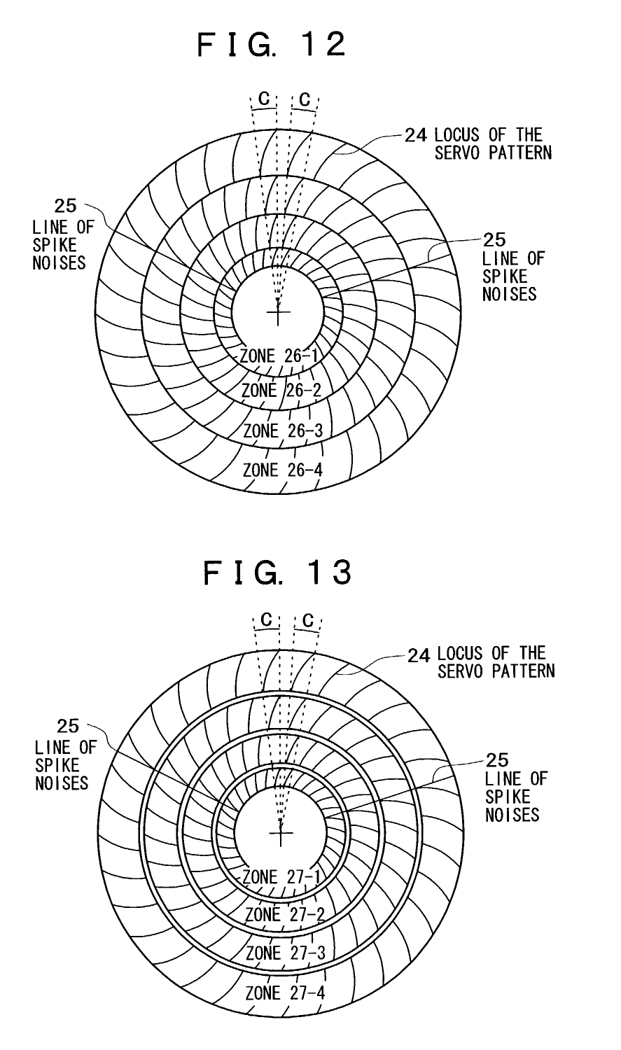

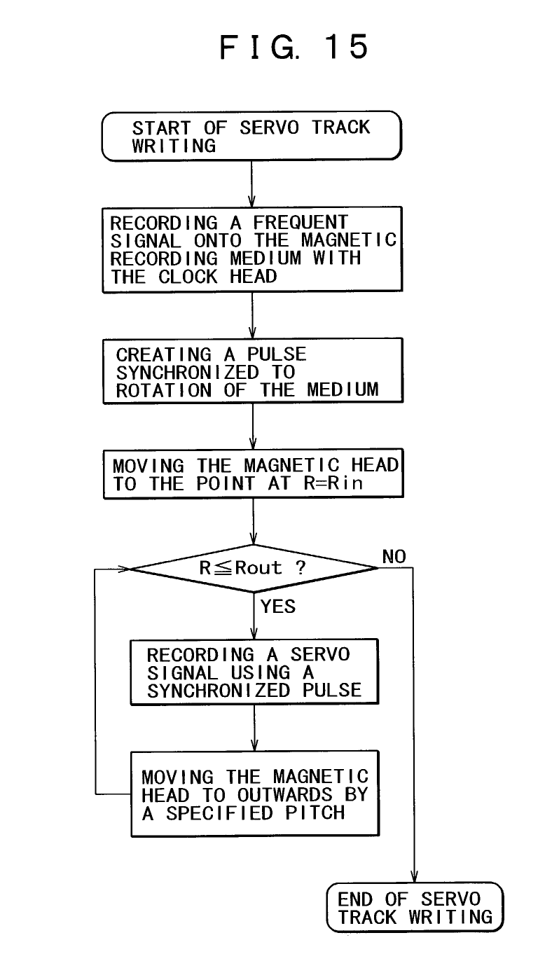

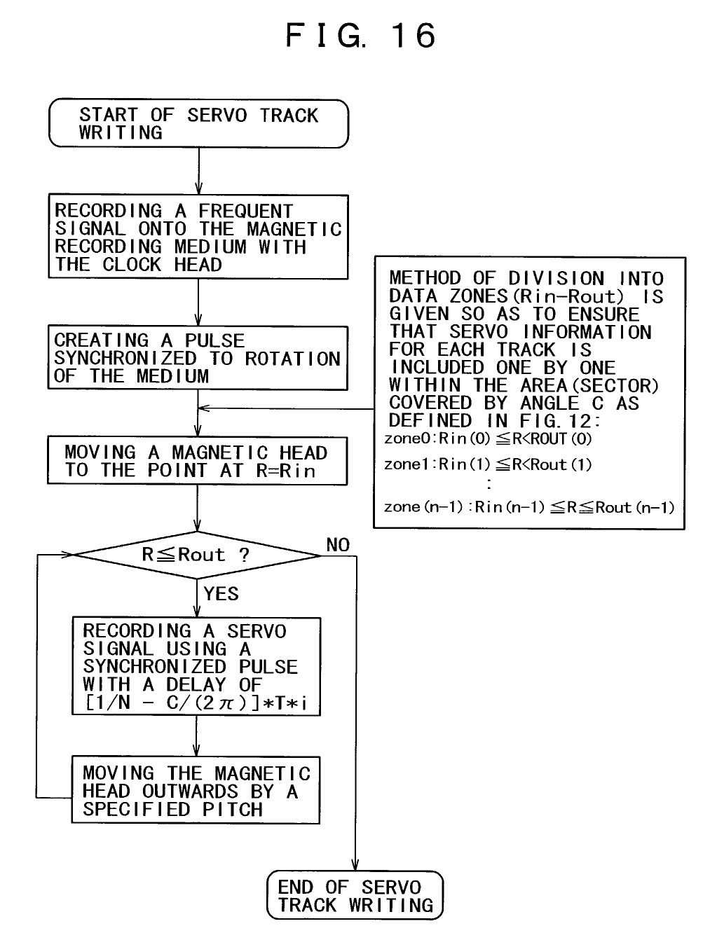

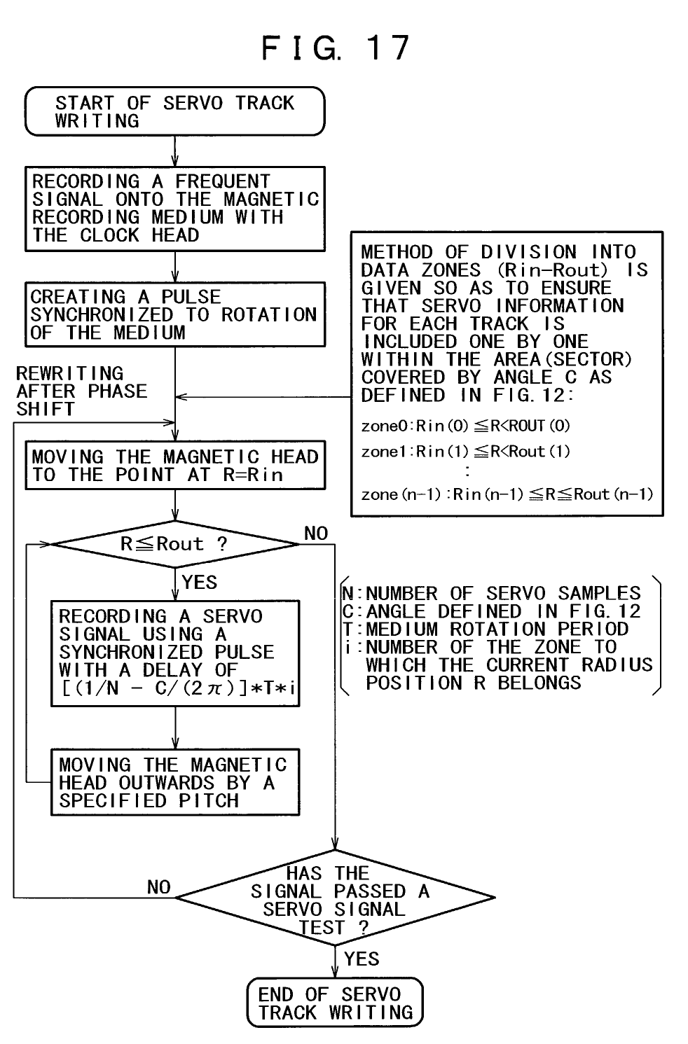

FIG. 12 shows an example of servo writing method to which the first embodiment is applied. For comparison, a sequence of servo writing based on the prior art is shown in FIG. 15. When spike noises are distributed in the radial direction as depicted in FIG. 11, if the prior art method were applied to servo writing, the locus of spike noises would inevitably crossed to the paths the servo pattern in at least one point. By contrast, servo writing is performed as described below in the first embodiment of the invention. The flow chart of servo writing according to a method used in the first embodiment is shown in FIG. 16. First, a frequency signal is recorded on the magnetic recording medium with the clock head to generate a pulse synchronized to the rotation of the recording medium. The steps mentioned so far are the same as in the conventional method. Then, as shown in FIG. 12, an angle C that satisfies the following relation is arbitrarily determined:

C<(2π)/N,

where N represents the number of servo samples.

The data area from its innermost radius Rin to its outermost radius Rout is divided into the following four zones:

Zone 0: Rin (0)=R<Rout (0) (corresponds to zone 26-1 in FIG. 12);

Zone 1: Rin (1)=R<Rout (1) (corresponds to zone 26-2 in FIG. 12);

Zone 2: Rin (2)=R<Rout (2) (corresponds to zone 26-3 in FIG. 12); and

Zone 3: Rin (3)=R<Rout (3) (corresponds to zone 26-4 in FIG. 12),

where R represents the head position and Rin (0) equals Rin, and Rout (3) equals Rout.

As an example, one way of dividing these zones is determined as follows. The servo information is recorded from Rin to the outermost side in the following order. First, with the servo sector recording position at Rin as the reference position, recording is made up to radius Rout (0) in the same manner as in the conventional method, until angle C is formed in the medium rotational direction. For shift to a next zone, the servo information at radius Rin (1) is recorded on an extension of the line which connects the medium pivot point and the servo information recording position at Rin.

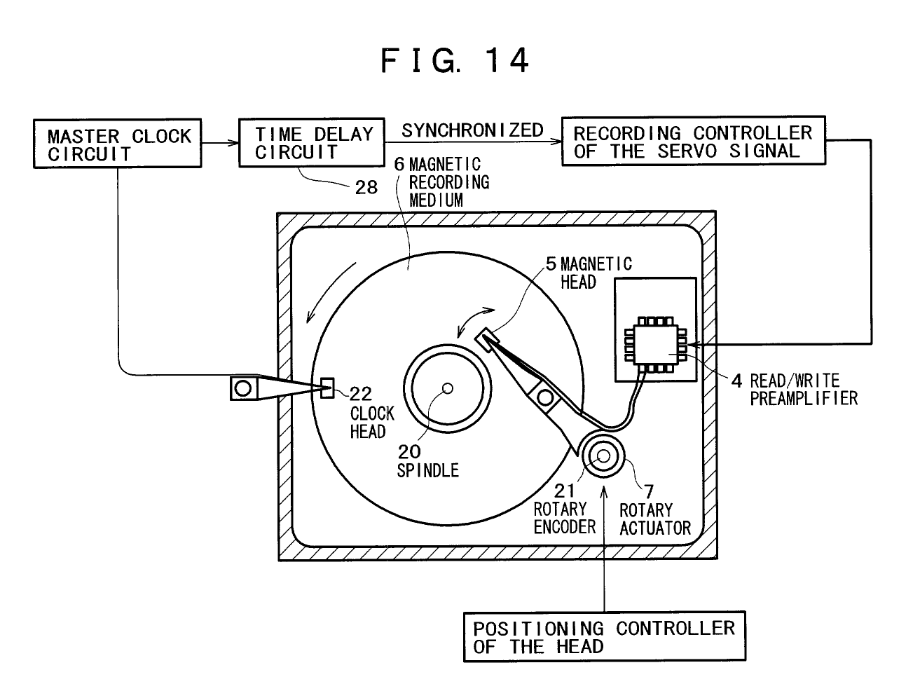

To perform recording in this way, the clock timing signal is delayed by the time lag calculated by following formula through a time delay circuit 28 in FIG. 14, and the servo information is recorded at the position of Rin (1).

Time Lag=[(1/N)−C/(2•)]*T,

where

N=number of servo samples; and

T=magnetic recording medium rotation period.

Thus, in recording the servo information sequentially up to a radius position of Rout (1), servo writing is consistently delayed by the time lag calculated according to [(1/N)−C/(2π)]*T. Then, when shifting to a next zone, the servo information at a position of radius Rin (2) is recorded on an extension of the line which connects the medium pivot and the position of servo information recording at Rin (Rin(0) or Rin(1)).

In the zone to shift, to perform recording in that way, the clock timing signal must be delayed by the time lag calculated as follows through a time delay circuit 28 (FIG. 14) to record the servo information at Rin (2).

Time Lag=[(1/N)−C/(2π)]*T*2,

where

N=number of servo samples; and

T=magnetic recording medium rotation period.

From here, in recording the servo information sequentially up to Rout (2) radius position, servo track writing must be consistently delayed by the lag time calculated according to [(1/N)−C/(2π)]*T*2. A zone shift and a clock timing delay are repeated in this way until servo information is recorded up to Rout to complete the entire servo writing process.

In the case of FIG. 11, a line of spike noises would inevitably cross the recorded servo information at two points since the prior art method was used for servo writing. By contrast, the servo information can be recorded in a position not crossing the locus of spike noises, if the method according to the first embodiment is employed. Since the servo sampling time can be determined arbitrary, no degrading of a servo bandwidth results as compared to the prior art.

The probability that the locus of the servo pattern crosses the line of spike noises becomes lower as the angle C becomes smaller, however, if the number of zones is too large, then the servo track writing process becomes too complicated. While angle C can be arbitrarily selected, in reality, angle C should be selected with taking the following points into consideration: spike noise distribution for each medium used and the tradeoff of the troublesomeness of a complicated servo track writing process.

Although this embodiment presumes that servo writing is done in the direction from Rin (innermost side) to Rout (outermost side), servo writing may also be done in the reverse direction, or from Rout to Rin, without departing the scope and spirit of the present invention.

This embodiment also presumes that the servo writing is carried out using the clock head, after the magnetic medium and the magnetic head are assembled into the magnetic disk apparatus. However, the servo writing method of the embodiment can be applied to another servo writing process in which a magnetic medium is installed into the magnetic disk apparatus after the servo recording is completed, such process is disclosed in Japanese laid-open patent P-A-73406/1991. In that way, the servo information is first recorded in a magnetic disk medium at a state of single disk (not assembled), next the medium with the recorded servo information is installed into the magnetic disk apparatus. Hence, in this case, not only the magnetic disk apparatus into which the medium is installed but also the medium itself that the servo information has been recorded are within the scope of this embodiment.

For the purpose of checking the spike noise distribution, the recording medium on which the servo area has been formed is inspected. One of the simplest ways of observing a state of the spike noise on a double-layer perpendicular recording magnetic medium is to make use an oscilloscope. When output of the head is observed using an oscilloscope, presence of a magnetic domain in the soft magnetic layer suggests that there are spike noises. The spindle motor usually outputs an index pulse (synchronized signal pulse to the rotation). Therefore, when the oscilloscope is triggered using this pulse, it is possible to know how many degrees away from the pivot spike noises will appear at that radius.

Embodiment 2

FIG. 13 shows an example of a servo writing method according to a second embodiment of the present invention. The difference from the first embodiment is that a space in which no data is to be recorded is provided between neighboring zones (27-1 to 27-4). If there are no such spaces between zones as those in the second embodiment and a significant off-track problem occurs in writing or reading data at each zone end (the innermost or outermost part of each zone), the servo signal in the adjacent zone may be accidentally read and stability in the process of following may be deteriorated. It is preferable to provide a space of 1 track to a few tracks between zones as a guard band. This space is a non-recorded area in which no meaningful signal such as servo data and user data is recorded. Although the non-recorded area is formed as a DC-erased area or AC-erased area in which no signal is recorded, it is preferable to record some dummy data therein in order to increase the stability in the automatic gain control circuit in PLL circuit. For dummy data to be recorded, repetitions of a single frequency signal may be used.

Embodiment 3

By applying the invention of embodiments 1 and 2 into practical use, the previous situation in which the line of spike noises cross the locus of the servo pattern can be improved. However, there is some possibility that spike noises will cross the servo pattern, because it is unknown before servo writing where spike noises occur. Therefore, a third embodiment of the invention specifies a rewriting method of servo information in a situation that spike noises have crossed the locus of the servo pattern even though the technology of the first or second embodiment was incorporated. The sequence according to the method used in the third embodiment is shown in FIG. 17. The first servo track writing process is the same as in the first embodiment. After completion of the first servo track writing process, a servo signal test is conducted. This test checks for any significant discontinuity in the servo signal, which is synchronized to the rotation of the medium. If any significant discontinuity is detected, in order to determine whether the servo error concerned is attributable to spike noises, the servo error must be logged and the position at which the circumferential direction the error has occurred should be determined. Once the circumferential position of occurrence of the error is determined, the servo pattern to be re-recorded will be shifted in time compared to the servo pattern that has been previously recorded with the use of the rotational synchronized pulse and the time delay circuit shown in FIG. 14. Thus, the locus of the servo pattern can be prevented from crossing the spike noises in the second trial of servo track writing.

The present invention also provides a servo writing method for making N servo areas in a magnetic recording medium wherein, assuming that Rin represents the radius for the innermost track of the magnetic recording medium, Rout represents the radius for the outermost track of the magnetic recording medium, line 1 represents the line connecting the pivot of the magnetic recording medium and a first arbitrary point on the track corresponding to radius Rout, line 2 represents the line connecting the pivot of the magnetic recording medium and a second arbitrary point on the track corresponding to radius Rout, the servo areas are divided in the radial direction of the recording medium so that there is only one servo sector for each track in the plane formed by the line 1, line 2, Rin and Rout.

Another feature of the servo writing method as mentioned above is that the magnetic recording medium is a perpendicular magnetic recording medium with a magnetic underlayer.

Other Embodiments (Methods and Medium)

A method of servo writing to magnetic recording medium is comprised of dividing a servo area into a plurality of zones in a radial direction of the medium performing servo writing to the divided servo area. Further, in the method mentioned above, said writing a servo area is proceed in a way that only one servo sector of for each track exist in a plane formed by the straight line 1, straight line 12, Rin and Rout, where Rin represents the radius for the innermost track of the magnetic recording medium, Rout represents the radius for the outermost track of the magnetic recording medium, straight line 1 represents a line connecting the center of the medium and a first arbitrary point on the track corresponding to the Rout, and straight line 2 represents a line connecting the center of the medium and a second arbitrary point on the track corresponding to the Rout.

Further, in the method above, step of providing a non-recorded areas between the zones could be contained. Further, in the method above, step of writing a dummy signal in said non-recorded area could be contained.

Furthermore, in the method mentioned above, step of putting a perpendicular magnetic recording medium with a magnetic underlayer to a spindle motor before writing servo pattern could be contained, which makes the perpendicular recording medium available in the method.

Also, another forms of application of the invention could be a perpendicular magnetic recording medium to which the servo pattern, which is comprised of a disk substrate, a magnetic recording layer, servo areas recorded in the magnetic recording layer, wherein said servo areas are divided into a plurality of zones in the radial direction.

In the medium mentioned above, the servo areas are divided in a way that at least one straight line connecting the center of the magnetic recording medium and arbitrary point in Rout on the magnetic recording medium exist, which doesn't contain any servo area. Further, in the medium mentioned above, the servo areas are divided in a way that only one servo sector of for each track exist in a plane formed by straight line 1, straight line 12, Rin and Rout, where the Rin represents the radius for the innermost track of the magnetic recording medium, the Rout represents the radius for the outermost track of the magnetic recording medium, the straight line 1 represents a line connecting the center of the medium and a first arbitrary point on the track corresponding to the Rout, and the straight line 2 represents a line connecting the center of the medium and a second arbitrary point on the track corresponding to the Rout. Further, the medium mentioned above can contain a non-recorded area formed between said zones. Furthermore, in the medium mentioned above, a dummy signal could be recorded in the non-recorded area.

Conclusion

As can be seen from the explanation given so far, the present invention ensures that servo writing on a magnetic disk is done while avoiding the influence of spike noises inherent to a perpendicular recording medium.

While the present invention has been described above in connection with the preferred embodiments, one of ordinary skill in the art would be motivated by this disclosure to make various modifications to these embodiments and still be within the scope and spirit of the present invention as recited in the appended claims.

What is claimed is:

1. A magnetic disk apparatus comprising:
a magnetic recording medium on which tracks having servo areas are formed;
a magnetic head which incorporates a write element and a read element; and
a rotary actuator,
wherein said servo areas are divided into a plurality of zones in the radial direction.

2. A magnetic disk apparatus according to claim 1, wherein,
said servo areas are divided into a plurality of zones in a radial direction so that a possibility for the servo area to intersect a magnetic domain wall created in the recording medium is decreased.

3. A magnetic disk apparatus according to claim 1, wherein,
said servo areas are divided into a plurality of zones in a radial direction so that a number of the servo area which intersects a magnetic domain wall created in the recording medium is less than or equal to one.

4. A magnetic disk apparatus according to claim 1, wherein,
said servo areas are divided into a plurality of zones in a radial direction so that an angle traversed by a servo pattern with respect to the center of the medium is decreased.

5. A magnetic disk apparatus according to claim 1, further comprising:
N servo areas on the magnetic recording medium;
a distance represented by D that is between a center of the magnetic recording medium and a pivot of the rotary actuator,
a distance represented by L that is between the pivot of the rotary actuator and a center of the write element or the read element,
a distance represented by R that is between a position of the magnetic head on a track and the center of the magnetic recording medium, and
a radial distance represented by Rin and Rout that represent the innermost radius and outermost radius of each track, respectively, wherein
said servo areas are divided into a plurality of zones in the radial direction of the recording medium in a manner satisfying the following relation:
0≦A<2π/N,
where A represents an angle formed by the rotary actuator pivot, the disk center and the head position on the track, angle A being defined by the equation:
A=arccos [(R²+D²-L²)/(2×R×D)].

6. A magnetic disk apparatus comprising:
a magnetic recording medium on which tracks having servo areas are formed;
a magnetic head including a write element and read element;
a rotary actuator;
N servo areas on the magnetic recording medium;
a distance represented by D that is between a center of the magnetic recording medium and a pivot of the rotary actuator,
a distance represented by L that is between the pivot of the rotary actuator and a center of the write element or the read element,
a distance represented by R that is between a position of the magnetic head on a track and the center of the magnetic recording medium,
a radius of the innermost track of the magnetic recording medium represented by Rin, and
a radius of the outermost track of the magnetic recording medium represented by Rout,
wherein the number of servo areas N and angle A formed by the rotary actuator pivot, the center of the magnetic recording medium and the head position on the track satisfy following formula:
N×(Amax−Amin)>2π
where the Amax and the Amin represent the maximum and minimum values of angle A within the range of Rin and Rout, respectively, and wherein A is defined by the following formula:
A=arccos [(R2+D2−L2)/(2×R×D)], and
wherein at least one straight line connecting the center of the magnetic recording medium and arbitrary point in Rout on the magnetic recording medium does not intersect any servo area.

7. A magnetic disk apparatus comprising:
a magnetic recording medium on which tracks having servo areas are formed;
a magnetic head which incorporates a write element and a read element; and
a rotary actuator,
N servo areas on the magnetic recording medium;
a distance represented by D that is between a center of the magnetic recording medium and a pivot of the rotary actuator,
a distance represented by L that is between the pivot of the rotary actuator and a center of the write element or the read element,
a distance represented by R that is between a position of the magnetic head on a track and the center of the magnetic recording medium,
a radius of the innermost track of the magnetic recording medium represented by Rin, and
a radius of the outermost track of the magnetic recording medium represented by Rout, wherein
wherein the number of servo areas N and angle A of formed by the rotary actuator pivot, the center of the magnetic recording medium and the head position on the track satisfy following formula:
N×(Amax−Amin)>2π
where the Amax and the Amin represent the maximum and minimum values of angle A within the range of Rin and Rout, respectively, and wherein A is defined by the following formula:
A=arccos [(R2+D2−L2)/(2×R×D)], and
wherein under an assumption that a first straight line connecting the center of the magnetic recording medium and a first arbitrary point on the track corresponding to Rout,
a second straight line 2 connecting the center of the magnetic recording medium and a second arbitrary point on the track corresponding to Rout,
angle C formed by said first straight line and said second straight line, and
said first arbitrary point and said second arbitrary point are selected in a way satisfying following formula,
C<2π/N,
only one servo sector for each track exists within the area formed by said first straight line, said second straight line and Rout.

8. The magnetic disk apparatus according to claim 6, wherein;
the servo areas are divided into a plurality of zones within a range of Rin and Rout.

9. The magnetic disk apparatus according to claim 7, wherein;
the servo areas are divided into a plurality of zones within a range of Rin and Rout.

10. The magnetic disk apparatus according to claim 1, wherein;
said magnetic recording medium is a perpendicular recording magnetic medium having a soft magnetic underlayer.

11. The magnetic disk apparatus according to claim 6, wherein;
said magnetic recording medium is a perpendicular recording magnetic medium having a soft magnetic underlayer.

12. The magnetic disk apparatus according to claim 7, wherein;
said magnetic recording medium is a perpendicular recording magnetic medium having a soft magnetic underlayer.

13. The magnetic disk apparatus according to claim 1, wherein:
the servo areas are divided into a plurality of zones; and
non-recorded areas are provided between adjacent zones.

14. The magnetic disk apparatus according to claim 6, wherein:
the servo areas are divided into a plurality of zones; and
non-recorded areas are provided between adjacent zones.

15. The magnetic disk apparatus according to claim 7, wherein:
the servo areas are divided into a plurality of zones; and
non-recorded areas are provided between adjacent zones.

16. The magnetic disk apparatus according to claim 1, wherein;
the servo areas are divided into a plurality of zones;
dummy data areas are provided between adjacent zones; and
a signal of single frequency is recorded on the dummy data areas.

17. The magnetic disk apparatus according to claim 6, wherein;
the servo areas are divided into a plurality of zones;
dummy data areas are provided between adjacent zones; and
a signal of single frequency is recorded on the dummy data areas.

18. The magnetic disk apparatus according to claim 7, wherein;
the servo areas are divided into a plurality of zones;
dummy data areas are provided between adjacent zones; and
a signal of single frequency is recorded on the dummy data areas.

19. The magnetic disk apparatus according to claim 10, wherein the anisotropic easy axis of the soft magnetic underlayer has a radial component.
